(19) United States
(12) Patent Application Publication
(10) Pub. No.: US 2008/0080354 A1
(43) Pub. Date: Apr. 3, 2008

(54) Optical disc playback equipment and optical disc playback method

(75) Inventor: Reiko Kawachi, Nishitama-gun (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/902,852

(22) Filed: Sep. 26, 2007

(30) Foreign Application Priority Data
Sep. 28, 2006 (JP) 2006-265787

(51) Int. Cl. G11B 7/00

(52) U.S. Cl. 369/100

(57) ABSTRACT

According to one embodiment, an optical disc playback equipment includes a reading section which outputs read information based on reflected light of laser light applied to an optical disc, an extracting section which extracts an URL from the read information output from the reading section, a communicating section which communicates with an external device via a network, and a control section which accesses the external device indicated by the URL by use of the communicating section and determines whether or not information can be downloaded when the extracting section detects the URL and generates and outputs a display signal indicating that attention is paid to setting of connection since information cannot be downloaded if the result of determination indicates that information cannot be downloaded.

### CROSS-REFERENCE TO RELATED APPLICATIONS

This application is based upon and claims the benefit of priority from Japanese Patent Application No. 2006-265787, filed Sep. 28, 2006, the entire contents of which are incorporated herein by reference.

### BACKGROUND

1. Field

One embodiment of the present invention relates to an optical disc playback equipment and optical disc playback method which download information from an external device by use of an URL stored in an optical disc.

2. Description of the Related Art

Recently, optical discs are developed and popularly used and various functions of optical disc playback equipments are proposed. As one of the functions, a function of accessing a site or the like on the network according to URL information contained in stored information of the optical disc and downloading information is known.

In Patent Document 1 (Jpn. Pat. Appln. KOKAI Publication, No. 2001-118324), a disc playback equipment is disclosed which can acquire related information associated with contents information recorded on a recording medium from a server via the network without causing the user to perform the troublesome operation by automatically reading out and executing a program recorded in a program recording area of the recording medium when the recording medium is mounted on the drive section.

However, the conventional technique disclosed in the Patent Document 1 is based on that the equipment functions while it is connected to the network and a process performed when it is not connected to the network is not described therein. When the equipment is not connected to the network, there occurs a problem that the user fails to acquire information in some cases even though a resource specified by the optical disc contents is present.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing one example of the configuration of a disc playback equipment according to one embodiment of this invention.

FIG. 2 is an explanatory view for illustrating one example of the operation screen of the disc playback equipment according to one embodiment of this invention.

FIG. 3 is an explanatory view for illustrating one example of a warning message displayed by use of OSD (On Screen Display) of the disc playback equipment according to one embodiment of this invention.

FIG. 4 is an explanatory view for illustrating one example of URL information stored in a disc read by the disc playback equipment according to one embodiment of this invention.

FIG. 5 is a flowchart for illustrating one example of a downloading process accompanied by warning display of the disc playback equipment according to one embodiment of this invention.

### DETAILED DESCRIPTION

Various embodiments according to the invention will be described hereinafter with reference to the accompanying drawings. In general, according to one embodiment of the invention, an optical disc playback equipment comprising:

a reading section which outputs read information based on reflected light of laser light applied to an optical disc;

an extracting section which extracts an URL from the read information from the reading section;

a communicating section which communicates with an external device via a network; and

a control section which accesses the external device indicated by the URL by use of the communicating section and determines whether information is downloaded when the extracting section detects the URL and generates and outputs a display signal indicating that attention is paid to setting of connection since information is not downloaded if the result of determination indicates that information is not downloaded.

According to one embodiment of this invention, an optical disc playback equipment and optical disc playback method which can stably download a resource of an URL specified by optical disc contents are provided.

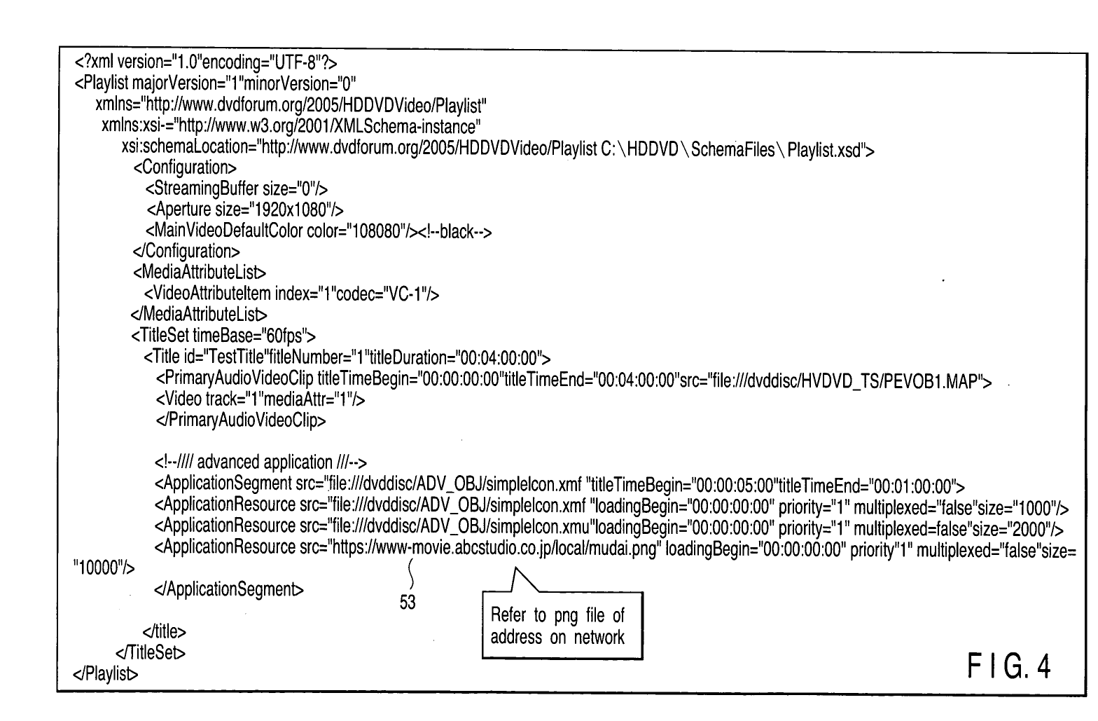

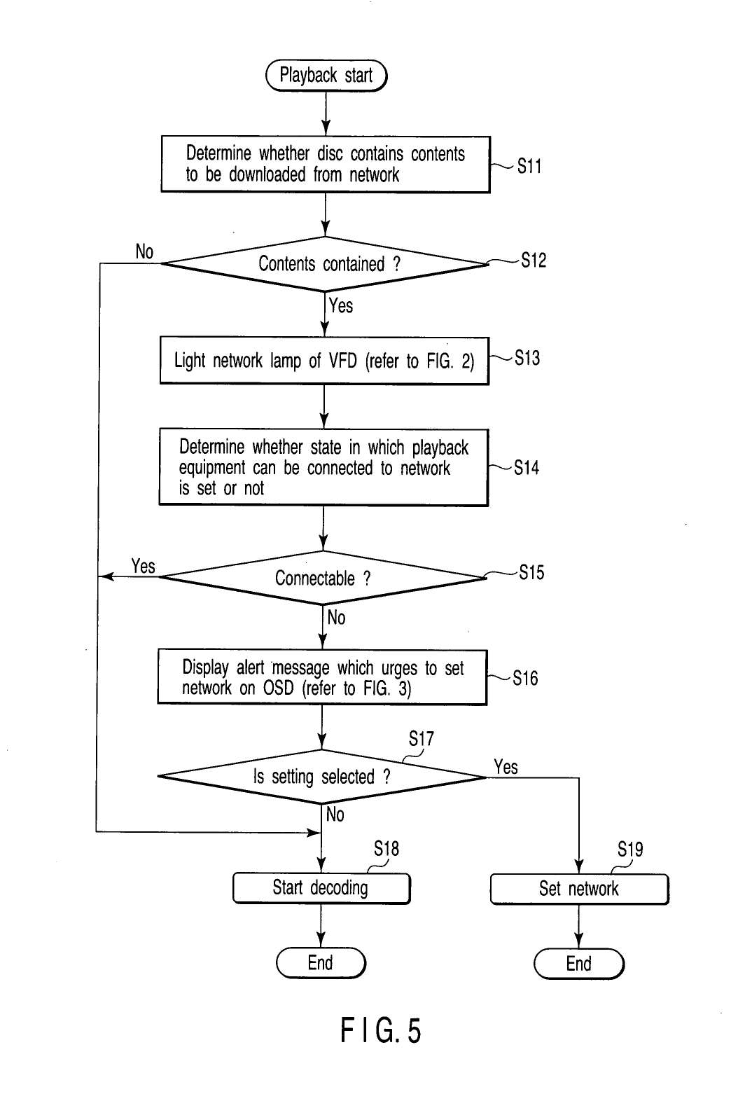

As means for solving the above problem relating to this invention, there is provided an optical disc playback equipment which includes a reading section (19) which outputs read information based on reflected light of laser light applied to an optical disc, an extracting section (34) which extracts an URL from the read information output from the reading section, a communicating section (11) which communicates with an external device via a network, and a control section (30, 35) which accesses the external device indicated by the URL by use of the communicating section and determines whether information can be downloaded when the extracting section detects the URL and generates and outputs a display signal (FIG. 3) indicating that attention is paid to setting of connection since information cannot be downloaded if the result of determination indicates that information cannot be downloaded.

According to the above optical disc playback equipment, if a resource of the URL specified by the optical disc contents is provided, it is determined whether or not the communicating section can communicate. If the communication cannot be made, the resource of the URL can be downloaded without fail by displaying to that effect.

Next, the embodiment of this invention is explained in detail with reference to the accompanying drawings.

### Optical Disc Playback Equipment According to One Embodiment of this Invention

(Configuration)

In this example, an optical disc playback equipment according to one embodiment of this invention is explained by using an optical disc recording/playback equipment having a hard disc recorder function as one example. However, the optical disc playback equipment has various configurations and it should be understood that all of them are contained in the range of the embodiment of this invention.

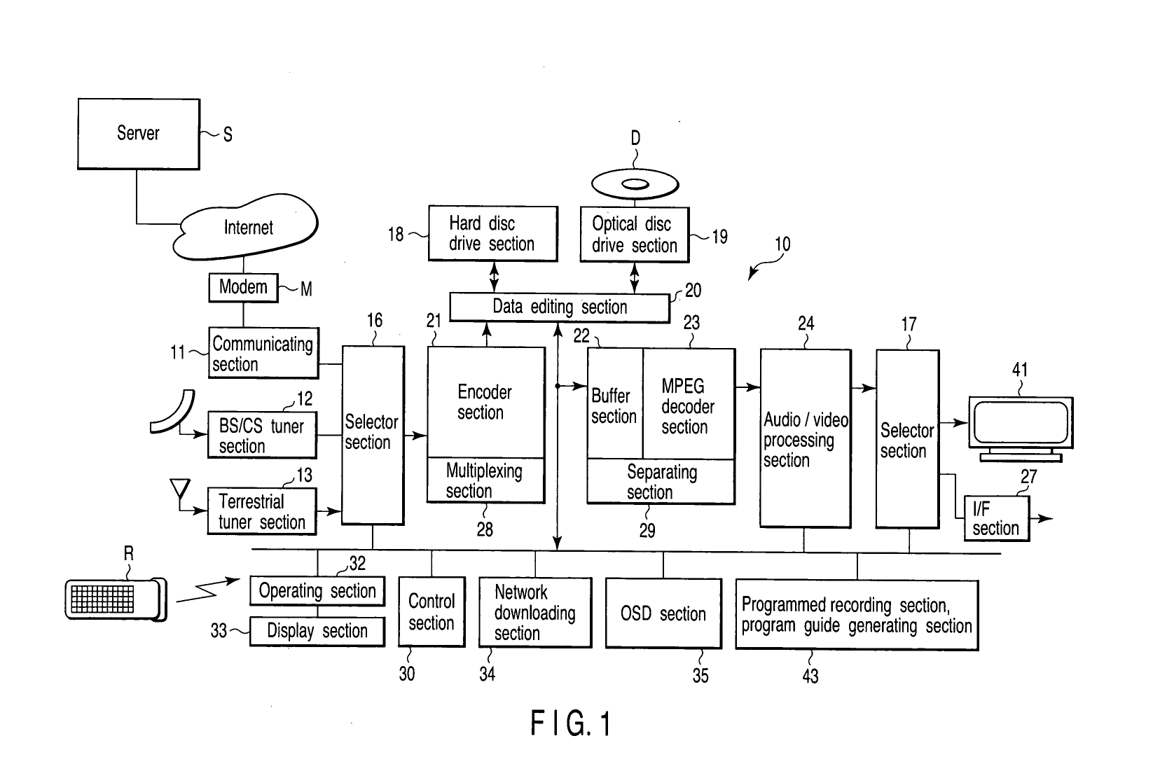

FIG. 1 is a block diagram showing one example of the configuration of the optical disc playback equipment 10 according to one embodiment of this invention. The optical disc playback equipment 10 of FIG. 1 includes two types of disc drive sections. First, the disc playback equipment 10 includes an optical disc drive section 19 which rotates and drives an optical disc D used as a first medium which is an information recording medium used to configure a video file and performs an information read/write operation. Further, it includes a hard disc drive section 18 which drives a hard disc as a second medium. A control section 30 is connected to the respective sections via a data bus to control the operation of the entire portion.

In addition, the optical disc playback equipment 10 of FIG. 1 includes an encoder section 21 which configures a recording portion, an MPEG decoder section 23 which configures a playback portion and the control section 30 which controls the operation of the equipment main body as main constituents. The optical disc playback equipment 10 has a selector 16 on the input side and a selector 17 on the output side. The selector 16 on the input side is connected to a communicating section 11 such as a LAN, so-called satellite broadcasting (BS/CS) tuner section 12 and so-called terrestrial broadcasting tuner section 13 and outputs a signal to an encoder section 21. Further, a satellite antenna is connected to the BS/CS tuner section 12 and a terrestrial antenna is connected to the terrestrial broadcasting tuner section 13. The optical disc playback equipment 10 includes the encoder section 21, a data editing section 20 which receives an output of the encoder section 21 and subjects the received output to desired data processing such as data editing, and the hard disc drive section 18 and optical disc drive section 19 which are connected to the data editing section 20. In addition, the optical disc playback equipment 10 includes an MPEG decoder section 23 which receives and decodes signals from the hard disc drive section 18 and optical disc drive section 19, encoder section 21, buffer section 22, MPEG decoder section 23, multiplexing section 28, separating section 29, control section 30, network downloading section 34, OSD (On Screen Display) section 35 and programmed recording section/program guide generating section 43. The above sections are connected to the control section 30 via the data bus. Further, an output of the selector section 17 is supplied to an external receiver 41 or to an external device via an interface section 27 which communicates with the external device.

Further, the optical disc playback equipment 10 includes an operating section 32 which is connected to the control section 30 via the data bus and operated by the user or operated by use of a remote controller R. In this case, the remote controller permits substantially the same operation as that performed by the operating section 32 provided on the main body of the optical disc playback equipment 10 and can be used to make various settings such as indication of editing or indication of recording or playback of the hard disc drive section 18 and optical disc drive section 19 or settings of programmed recording or the operation of the tuner.

(Basic Operation)

In the optical disc playback equipment 10 with the above configuration, the playback process and recording process are schematically explained by taking an optical disc as an example. Laser light is applied to an optical disc D rotated at a preset speed under the control of the control section 30, reflected light thereof is detected by an optical pickup and a detection signal based on the reflected light is output. Based on the detection signal, an RF signal is generated and the playback process is performed following after the data reading process.

In the recording process of the optical disc, for example, data supplied from an input/output section (not shown) via the selector section 16 is supplied to, coded by and output from the encoder section 21 under the control of the control section 30. The recording process is performed by supplying the drive current of a laser driver to the optical pickup according to the coded output and an output of the control section 30 and applying light to the storage area of the optical disc D.

Further, the broadcasting signal can be subjected to programmed recording on the hard disc drive section 18, optical disc D or the like and played back by utilizing the electronic program guide by use of the tuner sections 12, 13, programmed recording section 42 and program guide generating section 43.

### Downloading Process Accompanied by Warning Display

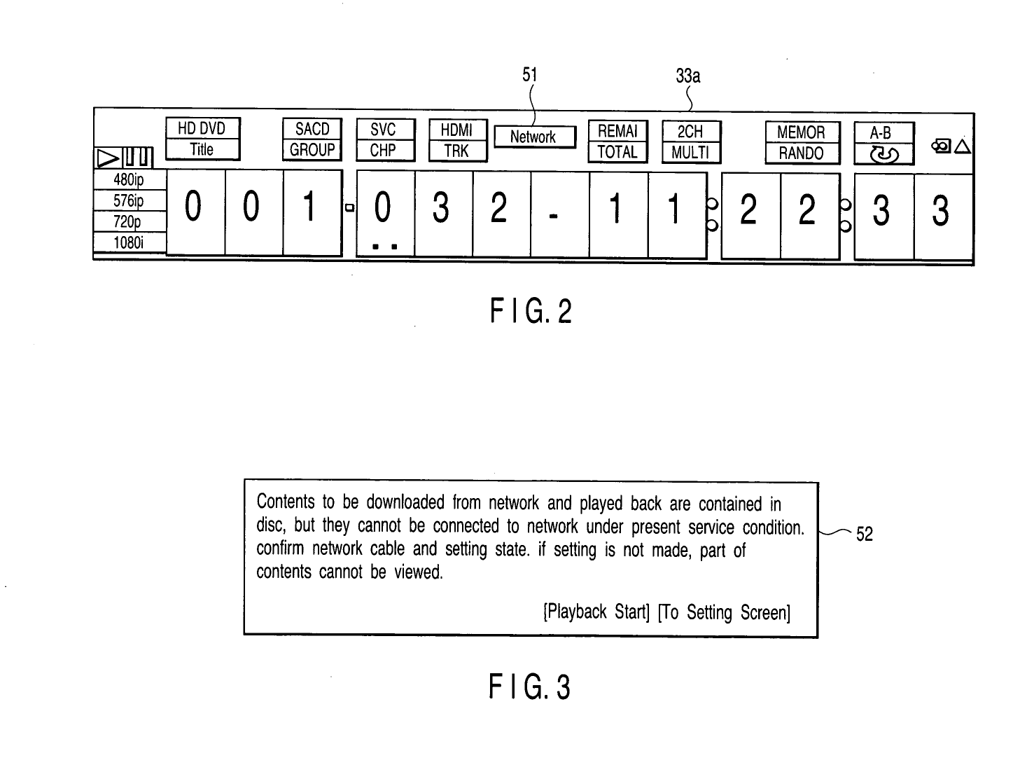

Next, the downloading process accompanied by warning display using the URL of the above optical disc playback equipment is explained in detail with reference to the flowchart. FIG. 2 is an explanatory view for illustrating one example of the operation screen of the disc playback equipment according to one embodiment of this invention. FIG. 3 is an explanatory view for illustrating one example of a warning message displayed by use of OSD (On Screen Display) of the disc playback equipment according to one embodiment of this invention. FIG. 4 is an explanatory view for illustrating one example of URL information stored in a disc read by the disc playback equipment according to one embodiment of this invention. FIG. 5 is a flowchart for illustrating one example of the download process accompanied by warning display of the disc playback equipment according to one embodiment of this invention.

The steps in the flowchart of FIG. 5 can be replaced by circuit blocks, and therefore, all of the steps of the flowchart can be re-defined as blocks.

In the disc playback equipment according to one embodiment of this invention, the downloading process accompanied by warning display is explained with reference to the flowchart of FIG. 5. First, the control section 30 and network downloading section 34 determine whether or not the optical disc contains contents to be downloaded from the network (step S11).

That is, when an optical disc such as an HD_DVD (High Definition Digital Versatile Disc) or normal DVD (Digital Versatile Disc) is inserted into the optical disc drive section 19, reflected light from the optical disc corresponding to laser light irradiated from an optical pickup (not shown) is read by the detector of the optical pickup and a read signal is output. Then, the network downloading section 34 analyzes the read signal and determines whether a function of downloading data from the network and playing back the same is contained in the disc or not based on the presence or absence of URL (Uniform Resource Locator) information as shown in FIG. 4.

In this case, as the concrete determination method, a method for making determination whether or not network access is made based on an identification flag in the optical disc and a method for making determination by analyzing the application contained in the optical disc are provided.

If the control section 30 and network downloading section 34 determine that the optical disc contains the contents to be downloaded (step S12), for example, they display to light a lamp of a network 51 of VFD which is a display section 33 as shown in FIG. 2 (step S13). Then, the control section 30 and network downloading section 34 determine whether a function of connecting the communicating section 11 to the site on the network indicated by the URL information is provided or not (step S15).

In this case, if the state in which the communicating section is connected is set, the process jumps to the step S18, the site on the network indicated by the URL information is accessed so as to download the contents and start the decoding process of the downloaded contents (step S18).

If it is determined by the control section 30 and network downloading section 34 in the step S15 that the communicating section 11 is not set in the state in which it is connected to the site on the network indicated by the URL information, the process proceeds to the step S16. Then, an alert display operation as shown in FIG. 3 is performed by use of the OSD (On Screen Display) section 35 so as to inform that the contents cannot be referred to. Further, a message which suggests to confirm cables and confirm the settings is displayed on the screen. The warning display or the like is not necessarily made on the OSD section and can be simply made on the display section 33.

In this case, if the user selects “Playback Start” on the screen (step S17), the playback process only for the contents of the optical disc is successively performed (step S18) without connecting the URL. If “Setting Screen” is selected, a network setting screen is displayed to permit an optimum setting to be selected while various setting items are sequentially confirmed and permit the communicating section 11 to be set into the communicable state (step S19).

It is preferable to freely select the function of the warning display or the like of FIG. 5 on the setting screen by use of the operating section 32. Thus, it becomes possible to provide a simple screen only for playback of the contents of the optical disc for the user who feels it troublesome to watch the warning display or the like.

As described above, it becomes possible to inform the user that additional contents can be observed by optimizing the setting of the communicating section 11 and connecting the same to the network. Further, the user can be prevented from being disturbed by informing the user that additional contents cannot be observed since the communication function of the communicating section 11 is insufficient.

According to the various embodiments described above, the person in the art can realize the invention. However, it is easy for the person in the art to think out various modifications of the above embodiments and those who have no inventive ability can apply this invention to various embodiments. Therefore, this invention extends to a wide range which is not inconsistent with the principle disclosed and the novel feature and is not limited to the above embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc playback equipment comprising:
a reading section which outputs read information based on reflected light of laser light applied to an optical disc;
an extracting section which extracts an URL from the read information from the reading section;
a communicating section which communicates with an external device via a network; and
a control section which accesses the external device indicated by the URL by use of the communicating section and determines whether information is downloaded when the extracting section detects the URL and generates and outputs a display signal indicating that attention is paid to setting of connection since information is not downloaded if the result of determination indicates that information is not downloaded.

2. The optical disc playback equipment according to claim 1, further comprising display means for displaying that information used to download information via the network is contained in the read information of the optical disc.

3. The optical disc playback equipment according to claim 1, further comprising an OSD section which outputs a synthesized signal of the read information and the display signal indicating that attention is paid to setting of connection since information is not downloaded to superimpose an image corresponding to the display signal on a screen image corresponding to the read information from the optical disc and display the superimposed image.

4. The optical disc playback equipment according to claim 1, wherein the control section selects whether information indicating that attention is paid to setting of connection since information is not downloaded is displayed based on setting contents.

5. A playback method of an optical disc playback equipment comprising:
outputting read information based on reflected light of laser light applied to an optical disc;
trying to extract an URL from the read information; and
permitting a communicating section which is provided in the optical disc playback equipment and communicates with an external device via a network to access the external device indicated by the URL and determine whether information is downloaded when the URL is extracted and generating and outputting a display signal indicating that attention is paid to setting of connection since information is not downloaded if the result of determination indicates that information is not downloaded.
